(19) United States
(12) Patent Application Publication
(10) Pub. No.: US 2019/0236607 A1
(43) Pub. Date: Aug. 1, 2019

(54) Transaction Aggregation and Multiattribute Scoring System

(71) Applicant: Perseuss B.V., Zaandam (NL)

(72) Inventors: Okke Formsma, Hilversum (NL); Maarten Alleman, Westzaan (NL)

(21) Appl. No.: 15/886,055

(22) Filed: Feb. 1, 2018

(51) Int. Cl. G06Q 20/40; G06N 7/00; G06N 99/00

(52) U.S. Cl. CPC G06Q 20/4016; G06N 99/005; G06N 7/005

(57) ABSTRACT

Systems and methods for aggregating commercial transaction information from a plurality of merchants, and evaluating them utilizing machine learning and artificial intelligence algorithms are disclosed. The commercial transaction information is parsed, aggregated, and evaluated based on patterns. One or more fraud clusters are generated based on the recognized patterns. The fraud clusters are utilized to generate a predictive fraud score for a transaction initiated by a customer. Interpretation of the predictive fraud score by a merchant allows the merchant to determine whether to allow the transaction to be completed or not by the customer.

### FIELD OF THE PRESENT TECHNOLOGY

The present technology relates generally to a transaction fraud scoring system using a combination of artificially intelligent fraud clusters and decision trees, as disclosed in greater detail herein.

### BACKGROUND

Internet-based commercial transactions are becoming an increasing share of overall commercial transactions for merchants. However, with Internet-based security facing constant attack, a merchant can never really be sure if a person initiating a commercial transaction via its website is a legitimate customer, or a fraudulent customer. A merchant may attempt to keep a running list of past known fraudulent customers and prevent that person from attempting a future transaction. However, a person with fraudulent intent may simply attempt a transaction with a competing merchant. The second merchant may then be vulnerable to approving a fraudulent transaction, simply because it does not have the data that the first merchant has regarding the real identity of the customer initiating the transaction.

Further, historical data shows that a significant portion of fraud attempts in e-commerce are committed from a select few types of organizations, such as criminal organizations. These organizations may target all merchants within certain industries, rather than only a singular merchant.

In order to protect all merchants within an industry, it is advantageous to aggregate historical information about completed commercial transactions in a central location, such that a comprehensive analysis can be completed on the larger data set and a more precise prediction can be made as to whether an initiated commercial transaction is likely to be from a legitimate customer or a fraudulent customer.

### SUMMARY

Various embodiments of the present technology provide a method for generating a predictive fraud score for an initiated commercial transactions, the method comprising: receiving a request from a merchant to evaluate a likelihood of an initiated transaction being a fraudulent transaction; parsing the request for discrete data attributes of the initiated transaction; utilizing one or more generated fraud clusters to determine if one or more of the discrete data attributes are in common with known fraudulent transactions, the one or more fraud clusters generated based on historical transaction data from a plurality of merchants over a time period; generating a predictive fraud score for the initiated transaction using one or more machine learning algorithms based on the one or more generated fraud clusters; and transmitting the generated predictive fraud score to the requesting merchant.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a high level schematic diagram of an exemplary environment for practicing aspects of the present technology.

FIG. 2 is another high level schematic diagram of an exemplary environment for practicing aspects of the present technology.

FIG. 3 is another high level schematic diagram of an exemplary environment for practicing aspects of the present technology.

FIG. 4 depicts an exemplary fraud cluster that is generated by practicing aspects of the present technology.

FIG. 5 depicts another exemplary fraud cluster that is generated by practicing aspects of the present technology.

FIG. 6 depicts an exemplary decision tree that may be executed by the system to generate a fraud score.

FIG. 7 is an exemplary flowchart of an example method of scoring commercial transactions in a computing environment.

FIG. 8 is another exemplary flowchart of an example method of scoring commercial transactions in a computing environment.

FIG. 9 is a schematic diagram of a computing system that is used to implement embodiments according to the present technology.

### DETAILED DESCRIPTION

The present disclosure is directed to various embodiments of systems and methods that use machine learning and artificial intelligence to generate a score representing a likelihood as to whether a particular requested commercial transaction is legitimate or fraudulent. The score is determined based on an aggregation of past commercial transaction data from a plurality of sources, analysis of the individual data components via fraud clusters, and a plurality of predictive algorithms organized in decision trees.

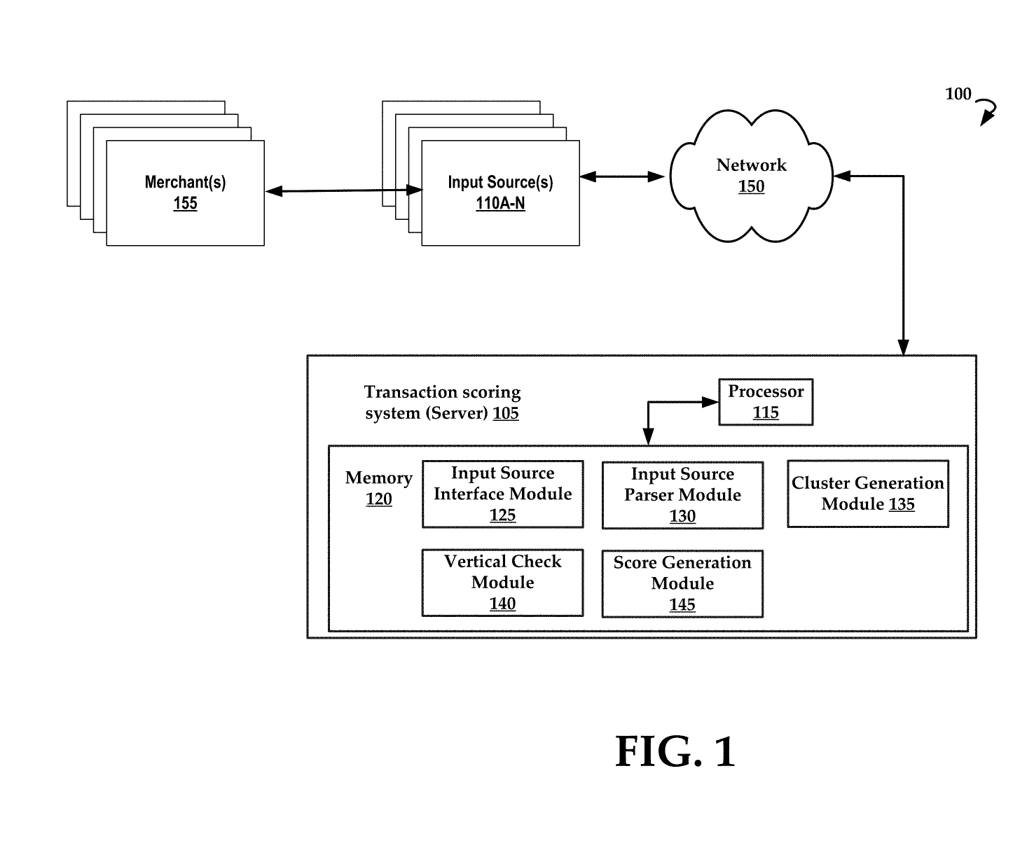

FIG. 1 is a high level schematic diagram of an exemplary environment 100 within which the present technology may operate. The exemplary environment 100 comprises an exemplary transaction scoring system 105 (hereinafter also referred to as exemplary system 105 or system 105 for short), which in some embodiments comprises one or more server or cloud-based computing device(s) configured specifically to perform the analyses described herein. That is, the system 105 in some embodiments is a particular purpose computing device that is specifically designed and programmed (e.g., configured or adapted) to perform any of the methods described herein. The system 105 can also comprise a plurality of distributed computing systems that cooperatively provide the features of the system 105. For example, individual ones of the plurality of distributed computing systems can provide one or more unique functions or services. In some embodiments, the system 105 can comprise a cloud computing environment or other similar networked computing system.

The system 105 can be coupled with a plurality of input sources 110A-N that provide input data to the system 105. An input source 110 can comprise, for example, a computing system, an enterprise network, a plurality of computing systems arranged as a network, virtual machines, application(s), network tap(s), services, a cloud, containers, or other similar computing environment that creates data instances. In some embodiments, the input source 110 comprises a database or data store that stores pre-obtained data from any of the aforementioned sources for use in accordance with the present disclosure.

Each input source 110 is also associated with a merchant 155 for commercial transactions. That is, a merchant 155 may have one or more input source(s) providing data to the transaction scoring system 105.

In one embodiment, the system 105 comprises at least one processor 115 and at least one memory 120 for storing instructions. The memory 120 can include an input source interface module 125, an input source parser module 130, a cluster generation module 135, a vertical check module 140, and a score generation module 145. As used herein, the terms “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

In some embodiments, the system 105 receives transaction data from the input source 110 via the input source interface module 125. The transaction data may include data regarding a plurality of discrete commercial transactions by a merchant, that are collected over a period of time. The individual data instances (or components thereof) may be time stamped so that a chronological order can be maintained for the data instances.

In some embodiments, using any one or more machine learning techniques, the exemplary system 105 can evaluate the data instances over time to generate a score representing a likelihood as to whether a particular initiated transaction is legitimate or fraudulent. Any one or more suitable supervised, unsupervised, or partially supervised machine learning techniques can be utilized for this purpose, as further described herein.

When data is received from any one of input sources(s) 110A-N, the exemplary input source parser module 130, shown in the example in FIG. 1, may be executed to separate or parse the input data into discrete data components or attributes that are ordered in time. That is, in various embodiments, the data instances are collected over a period of time and optionally time stamped as noted above. For example, the input source parser module 130 can break down data regarding a particular commercial transaction into discrete attributes [aᵢ^{j}] or properties of the transaction. In various embodiments, the input source parser module 130 considers the data [dᵢ] as a collection of attributes {dᵢ=(aᵢ¹, aᵢ², . . . , aᵢⁿ)}, where data represented by {} includes a set. The attributes can represent any property of a commercial transaction, such as customer name, customer email address, customer mailing address, customer phone number, shipping address for a product purchase, billing address, credit card information, IP address for a computing device used by a customer in the transaction, country of customer residence, currency, etc. Additional or fewer categorical attributes than the ones enumerated here can be utilized, in various embodiments. Any one or more attributes may be present in a particular data set received.

In various embodiments, the input source parser module 130 converts the categorical attributes into a collection of data set tuples (John Smith; Palo Alto, Calif.; IP address 1234.56.7.89). Other similar tuples can be created for other types of data sets, and can include a combination of numerical and/or non-numerical values.

While tuples are discussed herein for data sets, any method of parsing and organizing data can be used by the input source parser module 130, as would be understood by a person of ordinary skill in the art. The data can be stored in one or more databases for further analysis.

The database(s) of system 105 can be recalculated each time a new transaction is added, and hence clusters of the system 105 may be re-calculated and re-generated every time a new transaction is added, on a periodic schedule, or upon certain trigger conditions. The recalculation of the database is based on one or more of: internal links between the records (commonality of data attributes), pattern recognition, known fraud rings based on information from law enforcement, financial institutions, and/or other merchants.

In exemplary embodiments, a merchant may have been the target of an attack, and unwittingly authorized at least one fraudulent transaction. Once notified of the fraudulent nature of the transaction, the merchant may investigate and gather additional information regarding how the attack occurred. That is, the merchant may investigate as to whether the fraudulent transaction was authorized through its mobile app, website, in-person at its own store location, or through a third party app, website, or store location. For a store location, the merchant may be able to pinpoint which cash register authorized the use of the fraudulent payment method. For an online transaction, the merchant may be able to investigate an IP address used by the consumer to complete the fraudulent action, and possibly an IP source port, Internet Service Provider, geographic location, etc. Any and all information that can be gathered through an investigation of a fraudulent transaction may be transmitted by the merchant through an input source 110 to the transaction scoring system 105.

Merchants 155 may also transmit positive data to the transaction scoring system 105 as well. That is, data regarding completed transactions that were legitimate. In this way, the transaction scoring system 105 may have both positive and negative data points for analysis.

In various embodiments, merchants 155 reporting transaction data through input source 110 may all be from the same industry (such as airlines), or from disparate industries (such as some airlines and some retailers). The merchants 155 may be located anywhere in the world. There can be any number of participating merchants 155 gathering and sending data through input source(s) 110 to the transaction scoring system 105. In an exemplary embodiment, airlines operating in a plurality of countries across the world collect transaction data and transmit to the transaction scoring system 105.

In an exemplary embodiment where merchants 155 comprise one or more airlines, the data attributes collected and parsed may be unique to the industry. For example, data attributes may comprise the departing city, departing airport, arriving city, arriving airport, time of departure, day of week of departure, time of arrival, day of week of arrival, time between reservation and departure, etc. In addition, the portal through which an airline reservation was made can also be relevant. For example, whether the commercial transaction occurred or was initiated by the airline website, airline mobile application, third party website, third party mobile application, in person at an airport, or through a travel agent.

Once the input data has been collected and parsed, cluster generation module 135 evaluates the data to identify one or more patterns in the data regarding the commercial transactions via fraud clusters. For example, by analyzing one particular attribute, such as customer email address, the cluster generation module 135 can map all transactions using the customer email address, and see which other data attributes are shared between transactions using the email address. It may be that different customer names are used, but the same shipping address is used for all transactions. Alternatively, the IP address of the computing device initiating the transaction may be in common for all evaluated transactions of the email address. Another potential commonality may be that the same credit card is used for payment. In this way, by generating one or more fraud clusters by the cluster generation module 135, the transaction scoring system 105 can link different data elements together to identify fraudulent transactions via pattern recognition. For example, if all fraudulent transaction utilizing the same email address also have the same shipping address, then other transactions with that shipping address may also be fraudulent, even though they originated from a different customer email address. The cluster generation module 135 identifies patterns for fraud and links corresponding data elements together.

In some embodiments, a person evaluating the data of system 105 may manually link certain data attributes to one another to generate or update one or more clusters.

In other embodiments, a customer may purchase an item at a merchant 155 for delivery to one physical address. However, a courier may change the delivery address for any reason, such that the ultimate delivery address is different from the initial delivery address. Thus, the actual address that an item was delivered to may be a fickle point that does not provide much insight, or a specific data attribute that does provide valuable insight as to the nature of the commercial transaction. Evaluation of a combination of data attributes and linking of patterns between them, can yield valuable insight by the artificially intelligent system 105.

In still other embodiments, a delivery address from a food delivery service merchant may be more valuable than a delivery address from a retailer merchant. That is, a person is more likely to have food delivered to a physical location where they are actually present, whereas an item can be purchased from a retailer for delivery to any physical address. Thus, the system 105 can identify physical location of a person from one merchant 155 and utilize that information, in concert with other attributes, to evaluate an initiated transaction at a different merchant.

Further, in various embodiments, a large portion of fraudulent commercial transactions are committed by criminal organizations. The fraud clusters also help link new transactions to known criminal organizations. For example, a criminal organization may generally utilize a particular shipping address for receipt of illicitly purchased items. An attempted transaction by the criminal organization to a different shipping address, while utilizing the same customer email address, may imply that the criminal organization has a new warehouse for receipt of illicitly purchased items. In this way, new transactions can be linked to known fraudulent transactions to yield intelligence about criminal organizations. This information can be shared with merchants 155 and/or with law enforcement.

The transaction scoring system 105 can also conduct velocity checks within disparate merchants of an industry. For example, a person may attempt to purchase an airplane ticket from City 1 to City 2, to further a criminal enterprise. The person may approach a first airline and attempt to purchase such an airplane ticket. The first airline may decline the transaction for any reason. The person then attempts to purchase an airplane ticket between the two cities from a travel agent. The travel agent will not have the information from the first airline, and thus cannot know that the same person already attempted to book an airplane ticket from the first airline and was denied. However, since both the first airline and the travel agent are participating merchants 155 in the travel scoring system 105, the system 105 has the information regarding the denied transaction by the person at the first airline. The system 105 can deduce that the same person is attempting to complete the same transaction, just through a different merchant. Thus, the transaction scoring system 105 can provide a velocity check to the travel agent merchant, in the form of a fraud score that represents that the initiated transaction with the travel agent is suspicious.

As used herein, the term “fraudulent” transaction may refer to an unauthorized transaction by a legitimate customer, a transaction in furtherance of an illegal or other criminal purpose, or a transaction for which a customer never intends to pay for the item/service purchased from the merchant.

While a customer may attempt a fraudulent transaction at one merchant 155, that may not necessarily mean that the same customer is conducting a fraudulent transaction at every merchant 155. Additionally, which one transaction at merchant 155 may be fraudulent, the customer might also have another transaction at merchant 155 that is legitimate. These factors are taken into consideration by the system 105 via the vertical check module 140.

In one embodiment, a customer initiated legitimate transactions with five merchants, and a fraudulent transaction with a sixth merchant. A positive/negative list ratio may be generated by the system 105, which is taken into account by the artificial intelligence of the system 105 in generating the fraud score. The ratio may be generated for a person, based on a type of transaction, or any other criteria. Automatically deeming a person as a fraudster based on a single fraudulent transaction, or a small percentage of fraudulent transactions, may cause the person to be denied legitimate transactions at other merchants 155 within environment 100. However, merchants 155 want to sell their goods and services to legitimate users. Thus, merchants 155 have an interest in minimizing the number of transactions that are flagged as fraudulent when they are actually legitimate (false positives), due to the loss of revenue and customer goodwill from denying a transaction to a legitimate user.

In various embodiments, a person may defraud one merchant and use the proceeds in a legitimate manner at a second merchant. For example, the customer may be defrauding an airline, and is thus a fraudulent user at the airline merchant. However, the customer is using the proceeds gleaned from that fraudulent transaction to be a legitimate customer on a gambling website. The vertical check module 140 can analyze the customer's behavior and transaction data through all merchants to determine whether a particular initiated transaction is fraudulent or legitimate.

The score generation module 145 utilizes the fraud clusters generated by the cluster generation module, vertical check module 140, and walks through one or more decision trees to execute one or more computer algorithms to evaluate the likelihood and generate a prediction as to whether a particular initiated commercial transaction is fraudulent or legitimate. Through machine learning and artificial intelligence techniques, including neural networks, the score generation module 145 generates a numerical fraud score representing a likelihood that an initiated commercial transaction is fraudulent. In various embodiments, the score is on a scale of 1-1,000, or 1-100, or 1-10, or any other scale. Further, in some embodiments the score generation module 145 may yield a binary fraud score that is either a 0 or a 1, representing the prediction of legitimate or fraudulent. The fraud score is then transmitted through network 150 back to the merchant 155 that requested analysis of a particular initiated transaction. In exemplary embodiments, the fraud score is returned back to merchant 155 within 100 ms or less of the merchant requesting review of an initiated commercial transaction.

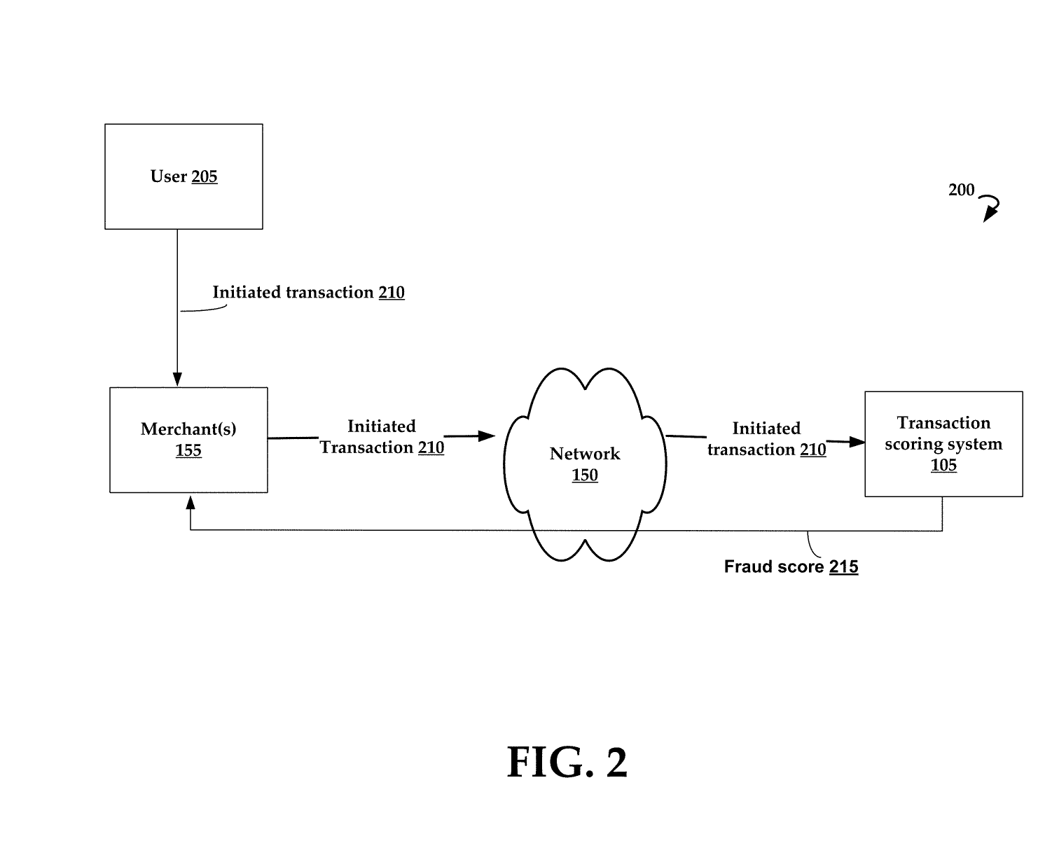

FIG. 2 illustrates an exemplary environment 200 within which the present technology may operate. A user 205 may initiate a transaction 210 with a merchant 155 of the environment 200. The merchant decides to query the transaction scoring system 105 as to whether the initiated transaction 210 is fraudulent or legitimate. The various modules of the transaction scoring system 105 parse the input data elements, as discussed above with respect to FIG. 1, fraud clusters associated with attributes of the initiated transaction 210 are reviewed and analyzed, one or more algorithms are executed in accordance with one or more decision trees, and then the transaction scoring system 105 generates a fraud score 215 for the initiated transaction 210. The fraud score 215 is a numerical value representing a likelihood as to whether initiated transaction 210 is a legitimate transaction or a fraudulent transaction. The fraud score 215 is transmitted back through network 150 to the merchant 155. Merchant 155 can then determine whether to allow user 205 to complete the initiated transaction 210 or not, based on its interpretation of the fraud score 215. In various embodiments, the transaction scoring system 105 generates fraud score 215 within 100 ms or less of receipt of initiated transaction 210.

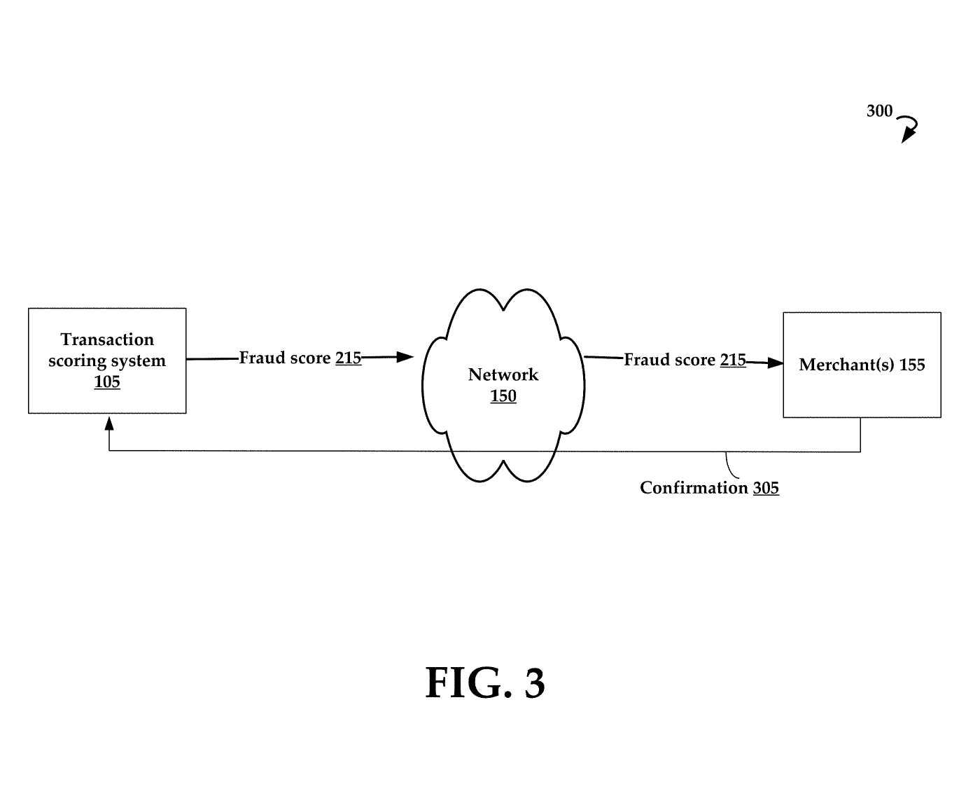

FIG. 3 illustrates another exemplary environment 300 within which the present technology may operate. The transaction scoring system 105 may generate and transmit fraud score 215 to merchant 155, via network 150. After merchant 155 either completes or denies the initiated transaction 210, merchant 155 may send a confirmation 305 back to the transaction scoring system 105. Confirmation 105 may contain information as to whether the transaction actually legitimate or fraudulent. The confirmation information may be gleaned by merchant 155 immediately upon completion or denial of initiated transaction 210, or sometime after. Further, confirmation 305 may be gleaned by merchant 155 after a separate investigation of initiated transaction 210, either before it is completed/denied, or afterwards. The confirmation 305 information is received by the transaction scoring system 105 and incorporated as an additional data point(s) for the fraud clusters.

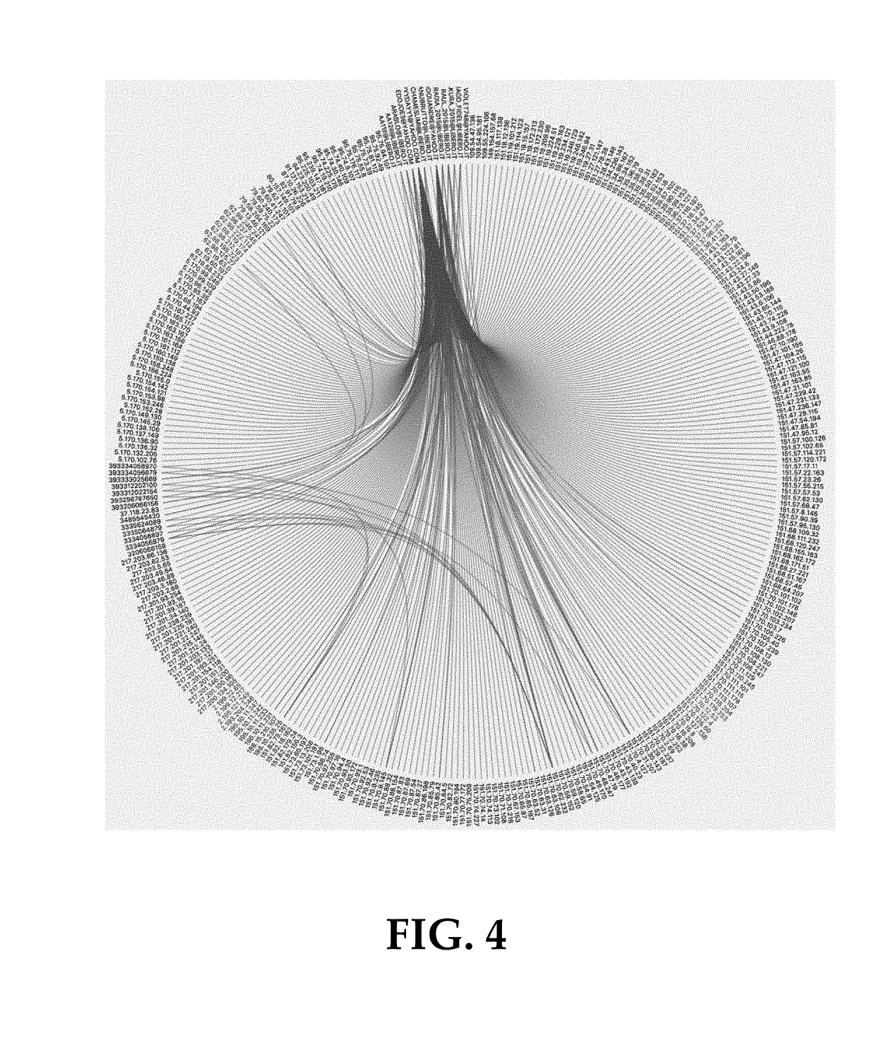

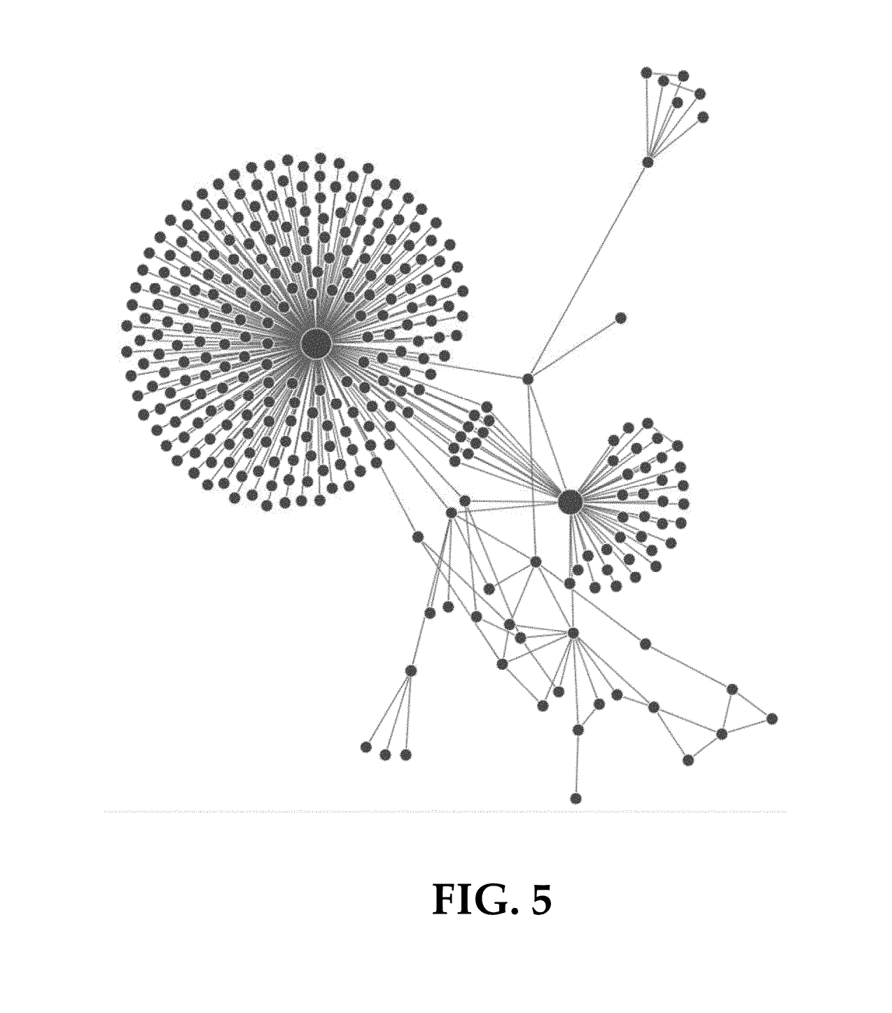

FIG. 4 and FIG. 5 depict exemplary clusters that can be generated by cluster generation module 135 and presented to a user via a graphical user interface of a computing device. The clusters depict grouped transactions for which one or more patterns have been recognized and data attributes have been linked. A user utilizing the system 105 has the option to click through any of the data points depicted to further investigate the elements.

In some embodiments, system 105 may monitor and track how each of the clusters (such as those depicted in FIG. 4 and FIG. 5), evolve and change over time. This change may yield information as to how a criminal organization's tactics for pursuing their illicit enterprise is changing and evolving. Information gleaned from these clusters may be transmitted to merchant(s) 155, law enforcement, and/or financial institutions.

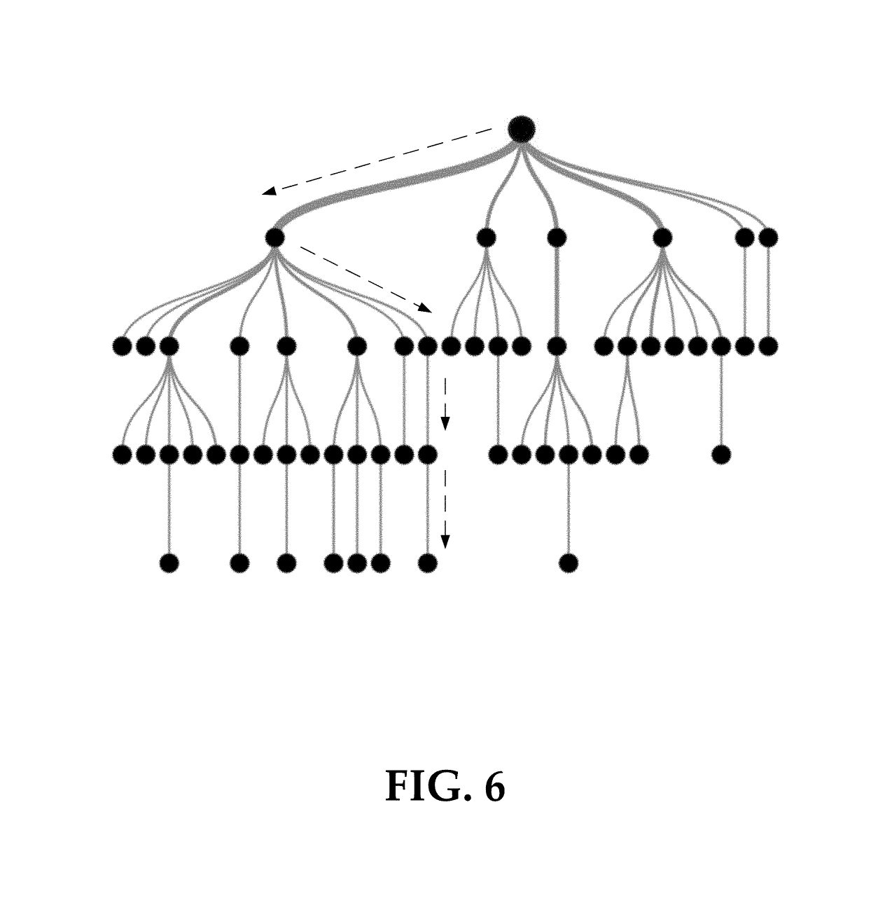

FIG. 6 depicts an exemplary decision tree that may be executed by system 105 to generate a fraud score. In various embodiments, the primary element in any particular decision tree is the fraud clusters. The particular path followed down the decision tree yields a determination of which one or more algorithms to execute by the system 105 to generate the fraud score. As would be understood by persons of ordinary skill in the art, any particular decision tree structure can be utilized to practice the present invention.

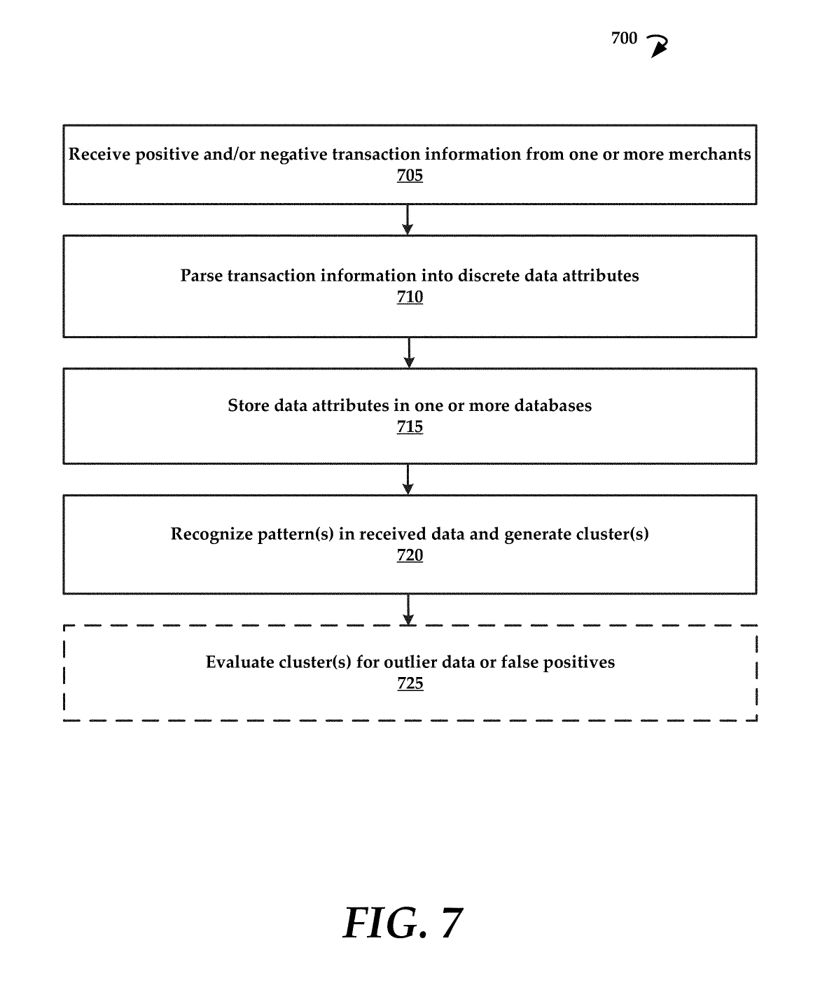

FIG. 7 is a flowchart of an example method 700 of scoring commercial transactions in a computing environment. The example method 700 comprises a step 705 of receiving an input data comprising positive and/or negative transaction information from one or more merchants. For example, transaction information can be received from one or more computing devices associated with a merchant. The transaction data may further be for any time period. The method includes parsing the transaction information into discrete data attributes in step 710. The particular data attributes present in the transaction data is variable based on how much information is available and provided by the merchant. Further, the data attributes present in the transaction data is variable based on the nature of the transaction. For example, an airline reservation will have different data attributes than a food delivery order from a restaurant, or a purchase from an online retailer.

The data attributes are then stored in one or more databases of system 105, in step 715. While the term “database” is used herein, a person of ordinary skill in the art would understood that any structure for storing data may be used.

In step 720, the system 105 utilizes one or more machine learning algorithms to recognize pattern(s) in the data present in the database and generate one or more clusters visually depicting the commonalities and links between data attributes of various transactions. Optionally in step 725, the cluster(s) can be evaluated for outlier data that should be discarded or for false positive data. Further, cluster(s) can be edited by a person to manually link or remove links between certain data attributes.

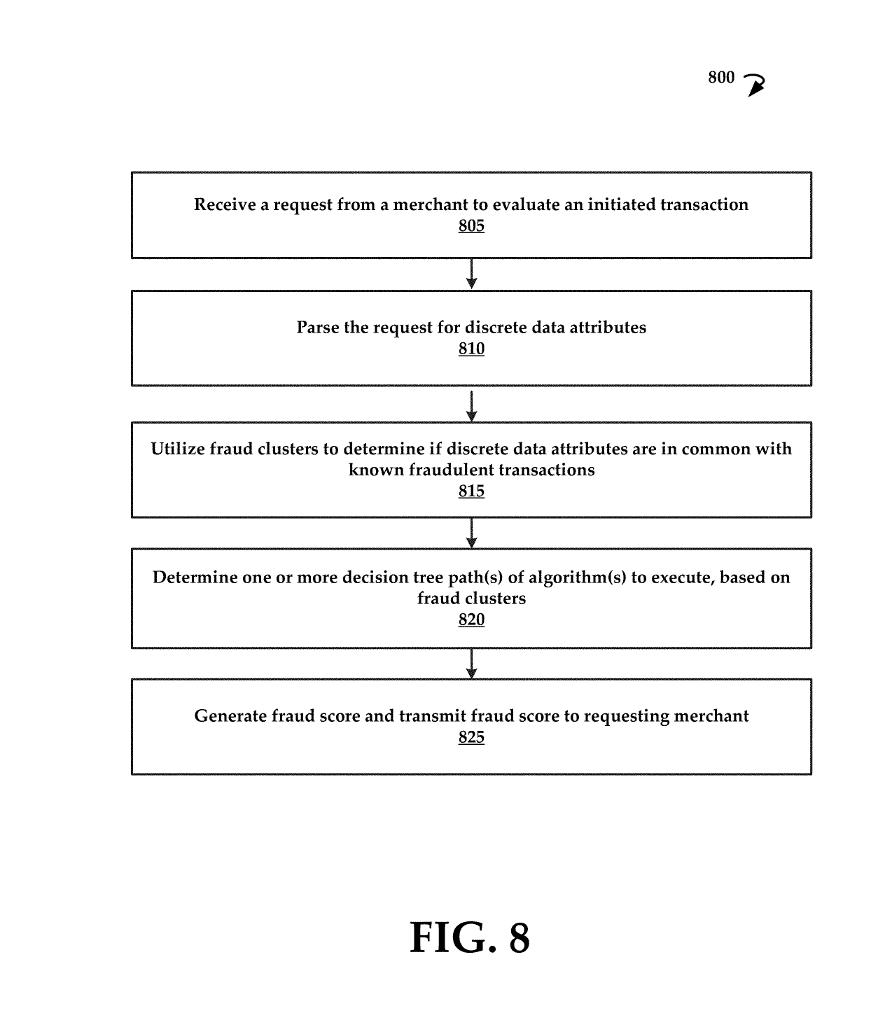

FIG. 8 is a flowchart of an example method 800 of scoring commercial transactions in a computing environment. The example method 800 comprises a step 805 of receiving a request from a merchant to evaluate an initiated transaction. In step 810, the system 105 parses the request for discrete data attributes of the initiated transaction. The data attributes of the initiated transaction are compared to known fraudulent data attributes utilizing one or more fraud clusters in step 815. In step 820, the system 105 determines one or more decision tree path(s) of algorithm(s) to execute, based on the fraud clusters. In step 825, the system 105 generates a predictive fraud score for the initiated transaction and transmits it to the requesting merchant.

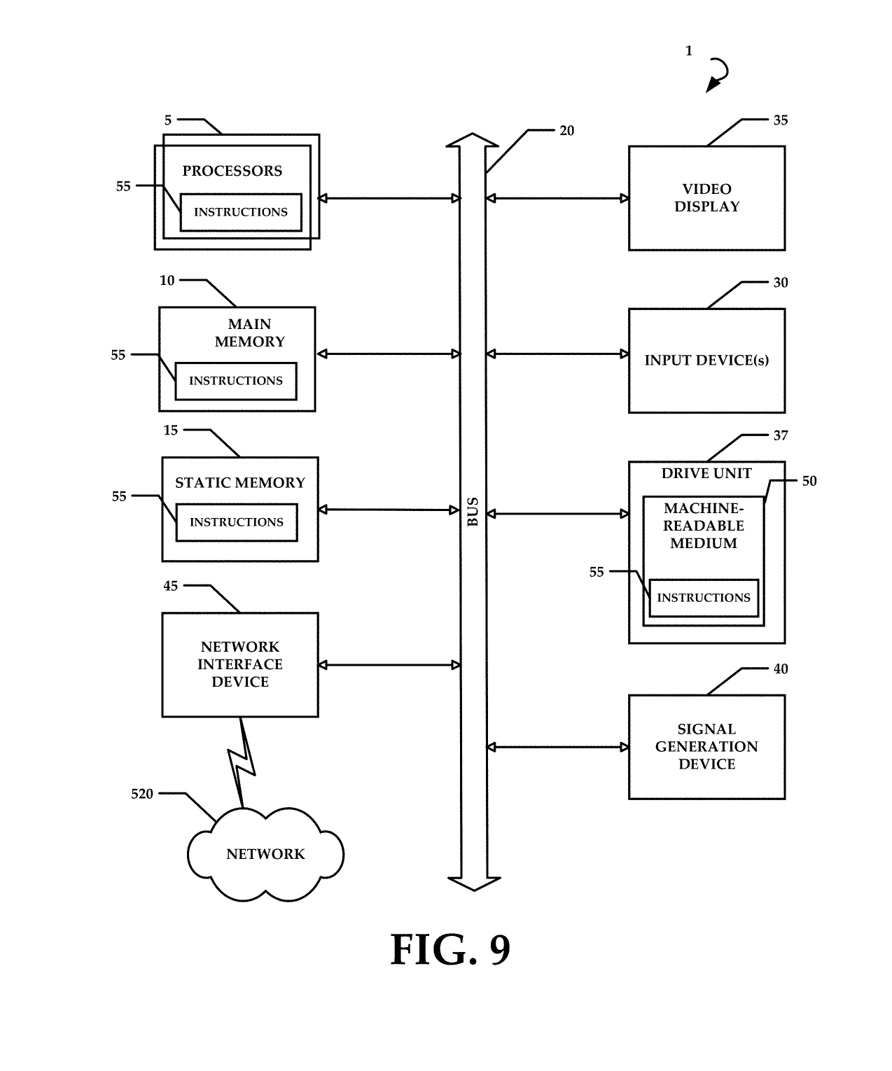

FIG. 9 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include input device(s) 30 (also referred to as alpha-numeric input device(s), e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a machine-readable medium 50 (which may be a computer readable medium) on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 150 of FIG. 1) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, environment, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method comprising:
receiving a request from a merchant to evaluate a likelihood of an initiated transaction being a fraudulent transaction;
parsing the request for discrete data attributes of the initiated transaction;
utilizing one or more generated fraud clusters to determine if one or more of the discrete data attributes are in common with known fraudulent transactions, the one or more fraud clusters generated based on historical transaction data from a plurality of merchants over a time period;
generating a predictive fraud score for the initiated transaction using one or more machine learning algorithms based on the one or more generated fraud clusters; and
transmitting the generated predictive fraud score to the requesting merchant.

2. The method according to claim 1, wherein the one or more generated fraud clusters are generated based on legitimate and fraudulent transaction data.

3. The method according to claim 1, wherein the one or more generated fraud clusters are generated based on transaction data from a plurality of merchants in the same commercial industry.

4. The method of claim 1, wherein the one or more generated fraud clusters are generated based on transaction data from a plurality of merchants in at least two commercial industries.

5. The method of claim 1, wherein the generated predictive fraud score is a numerical value between 1-100.

6. The method of claim 1, wherein the generated predictive fraud score is a numerical value that is either a 0 or a 1.

7. The method of claim 1, further comprising:
receiving confirmation information from the requesting merchant regarding whether the initiated transaction was completed as legitimate or fraudulent, the confirmation information comprising discrete data attributes for the completed transaction;
updating a transaction information database with the data attributes from the confirmation information; and
recalculating the one or more generated fraud clusters based on the updated transaction information database.

8. The method according to claim 1, wherein the transmitting the generated predictive fraud score to the requesting merchant occurs within 100 ms of receiving the request.

9. The method according to claim 1, wherein the one or more generated fraud clusters are manually edited by a human user.

10. A method comprising:
receiving positive and negative transaction data from a plurality of merchants, the positive transaction data comprising data for legitimate transactions and the negative transaction data comprising data for fraudulent transaction;
parsing the transaction data into data attributes of each transaction;
storing the data attributes for each transaction into one or more databases;
recognizing patterns in the stored data attributes using one or more artificial intelligence algorithms; and
generating one or more fraud clusters representing the recognized patterns among the stored data attributes.

11. The method according to claim 10, wherein the one or more generated fraud clusters are generated based on transaction data from a plurality of merchants in the same commercial industry.

12. The method according to claim 10, wherein the one or more generated fraud clusters are generated based on transaction data from a plurality of merchants in at least two commercial industries.

13. The method according to claim 10, wherein the one or more generated fraud clusters are manually edited by a human user

14. A system, comprising:
a processor; and
a memory for storing executable instructions, the processor executing the instructions to:
receive transaction data regarding completed commercial transactions at a plurality of merchants, the transaction data comprising multi-attribute data sets;
identify any of outliers and singularities in the received data;
group two or more of the completed commercial transactions into one or more groups based on correspondence between the multi-attribute data sets;
automatically calculate and generate one or more fraud clusters for the grouped data; and
generate an interactive graphical user interface that displays the one or more fraud clusters to a user, wherein the user can select any portion of each of the one or more fraud clusters to receive additional information regarding the underlying transaction data.

15. The system according to claim 14, wherein the processor executes the instructions to calculate a predictive fraud score for an initiated transaction at a merchant.

16. The system according to claim 14, wherein the generated one or more fraud clusters are generated based on transaction data from a plurality of merchants in the same commercial industry.

17. The system according to claim 14, wherein the one or more generated fraud clusters are generated based on transaction data from a plurality of merchants in at least two commercial industries.
